(19) United States
(12) Patent Application Publication
(10) Pub. No.: US 2025/0048409 A1
(43) Pub. Date: Feb. 6, 2025

(54) SIMULTANEOUS TRANSMISSION OF SUPPLEMENTARY UPLINK CARRIERS

(71) Applicant: QUALCOMM Incorporated, San Diego, CA (US)

(72) Inventors: Yiqing CAO, Beijing (CN); Peter GAAL, San Diego, CA (US); Alberto RICO ALVARINO, San Diego, CA (US); Masato KITAZOE, Hachiouji-shi, Tokyo (JP); Kazuki TAKEDA, Minato-ku, Tokyo (JP); Bin HAN, Beijing (CN); Juan MONTOJO, San Diego, CA (US); Wanshi CHEN, San Diego, CA (US)

(21) Appl. No.: 18/717,400

(22) PCT Filed: Feb. 11, 2022
(86) PCT No.: PCT/CN2022/076001

§ 371 Date: Jun. 6, 2024

(51) Int. Cl. H04W 72/51; H04L 5/00; H04W 56/00

(52) U.S. Cl. CPC H04W 72/51; H04L 5/001; H04W 56/0005

(57) ABSTRACT

Aspects are presented that enable a user equipment (UE) to perform simultaneous transmission of supplementary uplink carriers. The UE can transmit, to a base station, a capability message of the UE, the capability message indicating whether the UE supports simultaneous transmission of uplink signaling on supplementary uplink carriers. The UE can receive, from the base station, schedule information scheduling simultaneous transmission of a first uplink transmission on a first carrier in a first cell and a second uplink transmission on a second carrier in a second cell different from the first cell based on the capability message. The UE can transmit, to the base station, the first uplink transmission on the first carrier via the first cell simultaneous with the second uplink transmission on the second carrier via the second cell.

### BACKGROUND

### Technical Field

The present disclosure relates generally to communication systems, and more particularly, to wireless communication systems between a user equipment (UE) and a base station (BS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The apparatus can transmit, to a base station, a capability message of the UE, the capability message indicating whether the UE supports simultaneous transmission of uplink signaling on supplementary uplink carriers. The apparatus can receive, from the base station, schedule information scheduling simultaneous transmission of a first uplink transmission on a first carrier in a first cell and a second uplink transmission on a second carrier in a second cell different from the first cell based on the capability message. The apparatus can transmit, to the base station, the first uplink transmission on the first carrier via the first cell simultaneous with the second uplink transmission on the second carrier via the second cell.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 is a diagram of an example serving cell including a NUL and SUL carrier for a UE.

FIG. 5 is an example call flow diagram between a UE and a base station.

FIG. 6 is a flowchart of a method of wireless communication by a UE.

FIG. 7 is a flowchart of a method of wireless communication by a base station.

FIG. 8 is a diagram illustrating an example of a hardware implementation for an example apparatus.

FIG. 9 is a diagram illustrating an example of a hardware implementation for an example apparatus at a base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the present disclosure provide apparatus, methods, processing systems, and computer readable mediums for NR (new radio access technology or 5G technology). NR may support various wireless communication services, such as eMBB targeting wide bandwidth (e.g., 80 MHz or beyond), millimeter wave (mmW) targeting high carrier frequency (e.g., 27 GHz or beyond), mMTC targeting non-backward compatible MTC techniques, and/or mission critical targeting URLLC. These services may include latency and reliability requirements. These services may also have different transmission time intervals (TTI) to meet respective quality of service (QoS) requirements. In addition, these services may co-exist in the same subframe.

In some systems, such as NR, one or more supplemental uplink (SUL) carriers—not paired with a downlink carrier—can be configured in addition to a non-supplementary uplink carrier(s) (NUL). Thus, in some cases, there may be many uplink carriers to one downlink carrier. The scheduling cell may use cross-carrier scheduling on the downlink carrier sending downlink control information (DCI) scheduling one or more user equipment (UEs) for uplink data transmission to one or more cells on the uplink carriers, which may include SUL carrier and/or a NUL carrier.

In some NR systems, uplink transmission switching is allowed for up to four bands. In this regard, two SULs can be configured for a maximum of up to four bands when a primary cell and a secondary cell are both configured with SUL operation. However, some legacy NR systems are not configured to operate with multiple SUL carriers within one cell group, nor are the legacy NR systems considering multiple SUL transmission behavior.

The subject disclosure provides for defining the UE capability on simultaneous transmission for multiple SUL carriers and defining transmission switching rules for uplink transmission switching. Additionally, a UE may be configured with two uplink carriers from different cells, namely a SUL carrier and a NUL carrier, and the base station may semi-statically or dynamically schedule simultaneous uplink transmissions on either the NUL carrier or SUL carrier.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

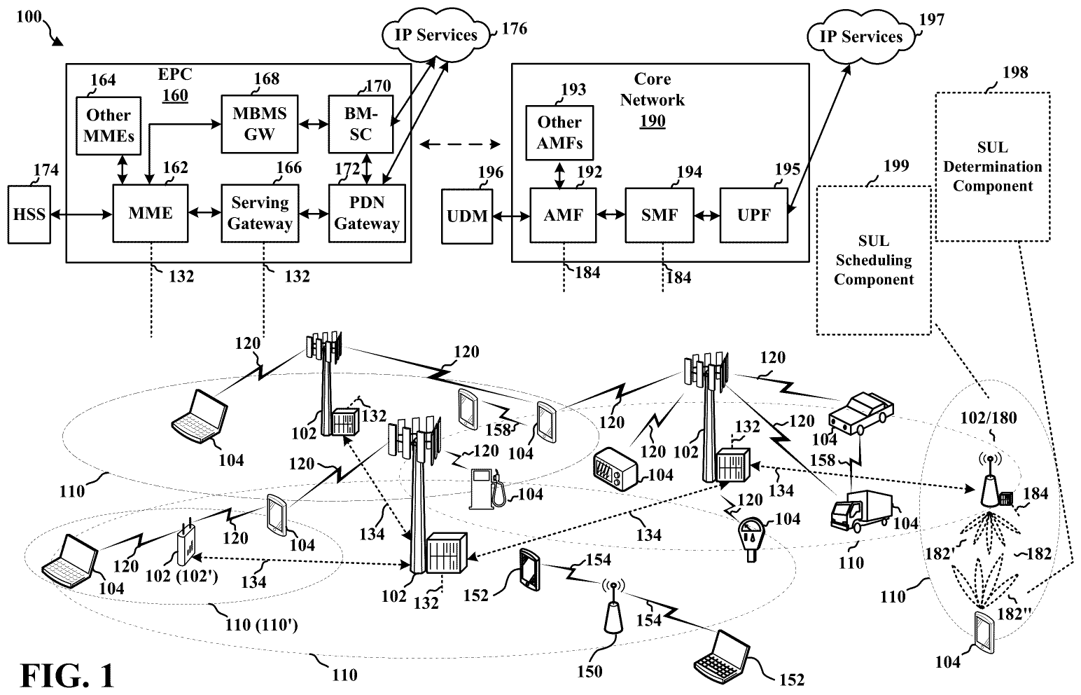

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a SUL determination component 198 configured to transmit, to the base station 102, a capability message of the UE, the capability message indicating whether the UE supports simultaneous transmission of uplink signaling on supplementary uplink carriers. The SUL determination component 198 may receive, from the base station 102, schedule information scheduling simultaneous transmission of a first uplink transmission on a first carrier in a first cell and a second uplink transmission on a second carrier in a second cell different from the first cell based on the capability message. The SUL determination component 198 may transmit, to the base station 102, the first uplink transmission on the first carrier via the first cell simultaneous with the second uplink transmission on the second carrier via the second cell. In other aspects, the base station 180 may include a SUL scheduling component 199 configured to receive, from the UE 104, a capability message of the UE, the capability message indicating whether the UE supports simultaneous transmission of uplink signaling on supplementary uplink carriers. The SUL scheduling component 199 may transmit, to the UE 104, schedule information scheduling simultaneous transmission of a first uplink transmission on a first carrier in a first cell and a second uplink transmission on a second carrier in a second cell different from the first cell based on the capability message. The SUL scheduling component 199 may receive, from the UE 104, the first uplink transmission on the first carrier via the first cell simultaneous with the second uplink transmission on the second carrier via the second cell. Although the following description may be focused on 5G NR, the concepts described herein may be applicable to other similar areas, such as LTE, LTE-A, CDMA, GSM, and other wireless technologies.

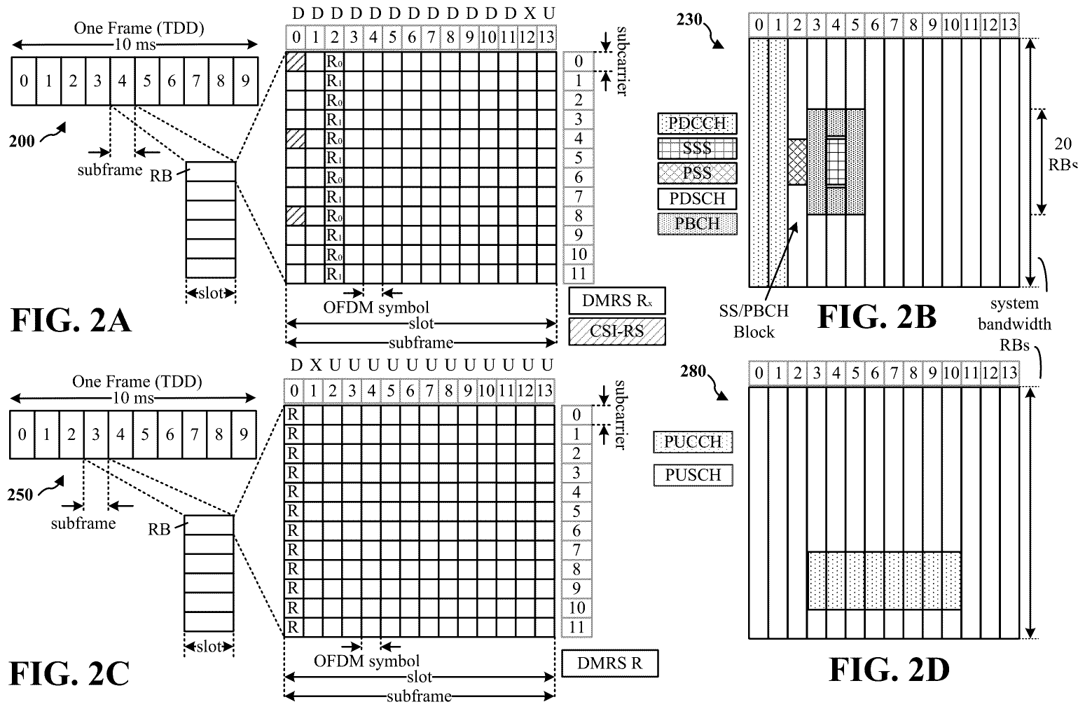

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where y is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

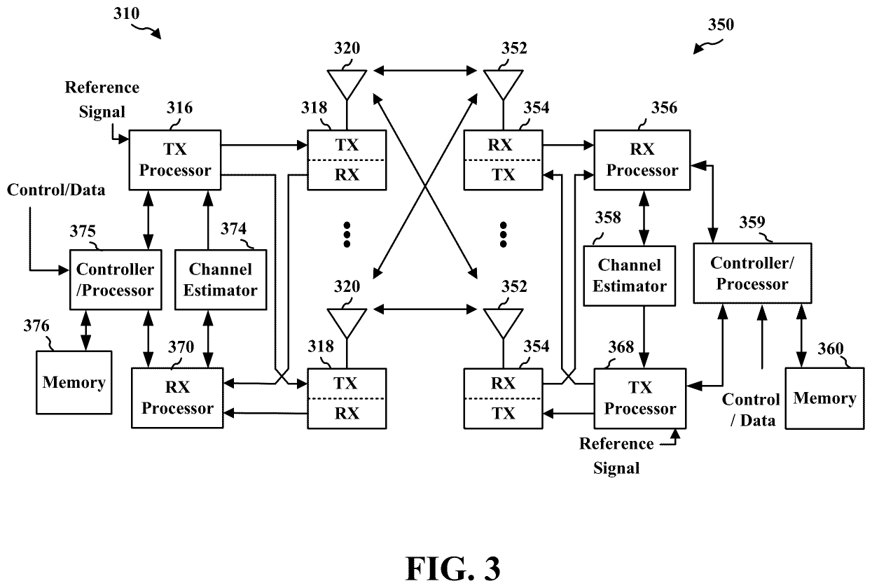

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

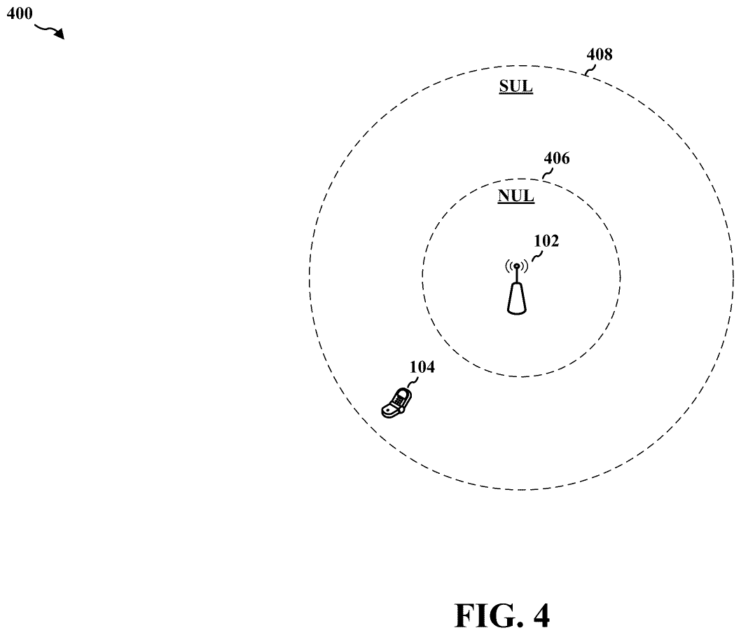

FIG. 4 is a diagram of an example serving cell 400 including a NUL and SUL carrier for a UE 104. In some aspects, an additional UL carrier located at a lower frequency to allow better uplink coverage in the event that the UE 104 is located at (or near) the cell edge. For example, the UE 104 may be configured with two uplink carriers in the same uplink serving cell, namely a supplementary uplink (SUL) carrier 408 and a non-supplementary uplink (NUL) carrier 406, and the base station 102 may semi-statically or dynamically schedule uplink transmissions on either the NUL carrier 406 or the SUL carrier 408. The example serving cell 400 may include a base station 102 that may communicate with the UE 104 over the NUL carrier 406 and the SUL carrier 408. The NUL carrier 406 and SUL carrier 408 may be located on different frequencies; for example, the NUL carrier 406 may be located at a higher frequency than SUL carrier 408. For example, a downlink/uplink carrier pair operating in the 3.5 GHz band can be complemented with a supplementary uplink carrier in the 800 MHz band. The NUL carrier 406 and the SUL carrier 408 may have different ranges, e.g., as illustrated in FIG. 4. The base station 402 may send an uplink grant to the UE 404 to communicate on either the NUL or the SUL; the UE 104 may not simultaneously transmit uplink communications on NUL and SUL. For example, in a serving cell, the UE 104 may be dynamically or semi-statically indicated by the base station 102 to transmit PUSCH, SRS, PUCCH, or other uplink communications on either the NUL carrier 406 or the SUL carrier 408.

As illustrated in FIG. 4, in a first area where uplink coverage is good (or at least satisfies a performance threshold), the UE 104 may utilize the NUL carrier 406 for uplink transmission. When the UE 104 moves to the area where UL coverage may be limited, the base station 102 can still provide sufficient downlink coverage through increased downlink transmission power; however, the UE 104 may not be capable to match that performance due to power restrictions in the uplink. Therefore, to achieve improved uplink coverage, the UE 104 can select the SUL carrier 408 that is located at a lower frequency band than the NUL carrier 406. SUL specifically serves to provide the UE 104 with better uplink coverage such as higher uplink data rates in power-limited situations by utilizing the lower path loss at lower frequencies.

In some aspects, the UE 104 can be configured with up to four bandwidth parts in the uplink with a single uplink bandwidth part being active at a given time. If the UE 104 is configured with a supplementary uplink carrier, the UE 104 can in addition be configured with up to four bandwidth parts in the supplementary uplink carrier with a single supplementary uplink bandwidth part being active at a given time. In some aspects, the UE 104 may not transmit PUSCH or PUCCH outside an active bandwidth part. For an active cell, the UE 104 may not transmit SRS outside an active bandwidth part.

In a SUL scenario, the NUL carrier 406 may be significantly more wideband compared to the SUL carrier 408. Thus, under good channel conditions such as the UE 104 being located relatively close to the cell site (e.g., 102/180), the NUL carrier 406 can allow for substantially higher data rates compared to the SUL carrier 408. Alternatively, under bad channel conditions, for example, at the cell edge, a lower-frequency SUL carrier 408 may allow for significantly higher data rates compared to the NUL carrier 406, due to the assumed lower path loss at lower frequencies.

When the uplink coverage of the NUL carrier 406 meets a performance threshold, the UE 104 may utilize the NUL carrier 406 to send and receive data. However, when the UE 104 is moving beyond the uplink coverage of the NUL carrier 406, the UE 104 may utilize the SUL carrier 408 for transmitting data. In some aspects, the UE 104 can dynamically select the NUL carrier 406 or the SUL carrier 408 for data transmission. However, the UE 104 may not utilize the two carriers at the same time in the same cell.

Aspects of the present disclosure provide for the simultaneous transmission of supplementary uplink carriers from different cells. The UE may generate a capability message indicating whether the UE supports simultaneous transmission of uplink signaling on supplementary uplink carriers. The UE 104 may generate the capability message based on one or more transmission switching rules stored in tables on the UE 104. The UE 104 may transmit, to the base station 102, the first uplink transmission on a first carrier via a first cell simultaneous with the second uplink transmission on a second carrier via a second cell. In some aspects, the first cell is a primary cell and the second cell is a secondary cell. In some aspects, the first cell and the second cell are associated with a same cell group. In other aspects, the first cell and the second cell are associated with different cell groups.

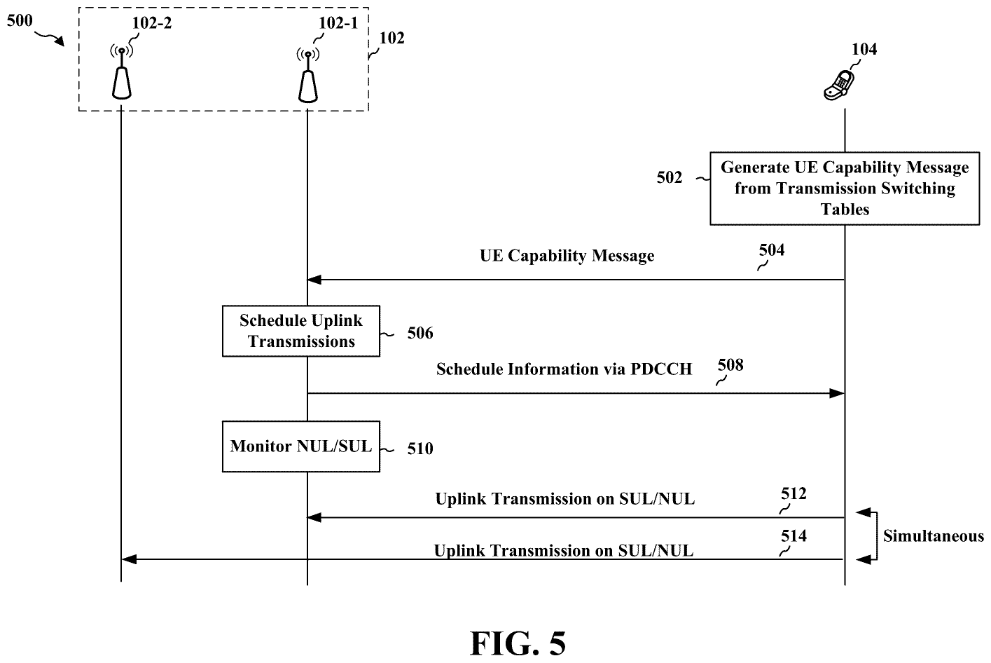

FIG. 5 illustrates an example call flow diagram 500 between the UE 104 and the base station 102. At block 502, the UE 104 may generate a UE capability message from one or more transmission switching tables. The UE capability message may indicate on which band pairs the UE 104 supports simultaneous transmission of multiple SULs. For example, within the UE capability message, the UE can indicate that it supports simultaneous transmission of SRS/PUSCH on an SUL carrier in one cell (primary cell) and transmission of SRS/PUSCH on another SUL carrier in another cell (e.g., secondary cell). In some aspects, the UE 104 may support simultaneous transmission on an SUL band X and a SUL band Y, where X and Y may correspond to different frequency ranges. In some implementations, the simultaneous transmission of multiple SULs may be only applicable for FR1 (e.g., under 6 GHz operating frequencies). In any case, the simultaneous transmission of SUL and NUL carriers in one cell may not be allowed.

In some implementations, the UE 104 may store the one or more transmission switching tables in firmware or in non-volatile memory of the UE 104. In one or more implementations, the UE 104 may be configured with a first transmission switching table (Table 1) that sets rules for the UE 104 to have a capability that supports the simultaneous transmission of any carriers (e.g., NUL, SUL) in one cell and any of the carriers (e.g., NUL, SUL) in another cell, while the carriers can be either SUL or NUL between the different cells. In each of Tables 1 and 2, the transmission status of each band may be expressed as aT+bT+cT+dT+ . . . , where T corresponds to a transmission chain and each coefficient (e.g., a, b, c, d) may correspond to a logical value indicating whether the corresponding transmission chain is active.

As illustrated below in Table 1, a first case indicates that two bands among the band pairs can be selected to support the simultaneous uplink transmissions, in which each selected band may correspond to either SUL carriers or NUL carriers depending on its frequency range of operation. In some aspects, two or more of the bands are configured for SUL operation, assuming bands A and B are associated with a first cell (e.g., band A is NUL and band B is SUL) and bands C and D are associated with a second cell (e.g., band C is NUL and band D is SUL). In some aspects, the first cell and the second cell are associated with a same cell group. In other aspects, the first cell and the second cell are associated with different cell groups. In one or more implementations, the one or more switching rules may indicate that one or more band combinations (e.g., bands B and D) in the plurality of band pairs (e.g., bands A-D) are allowed to support simultaneous transmission of multiple supplementary uplink carriers that are associated with the one or more band combinations. In one or more other implementations, the one or more switching rules may indicate that one or more band combinations (e.g., bands A and C) in the plurality of band pairs are allowed to support simultaneous transmission of multiple non-supplementary uplink carriers that are associated with the one or more band combinations. In still other implementations, the one or more switching rules may indicate that one or more band combinations (e.g., bands A and D, or bands B and C) in the plurality of band pairs are allowed to support simultaneous transmission of a supplementary uplink carrier and a non-supplementary uplink carrier that are associated with the one or more band combinations.

As further illustrated below, the transmission status of each band for case 1 may vary based on the transmission switching rules. In a first valid case, the transmission status of case 1 can be expressed as 1T+0T+1T+0T+ . . . , where two NULs from primary and secondary cells may be transmitted simultaneous. Similarly, in a second valid case, the transmission status of case 1 can also be expressed as 0T+1T+0T+1T+ . . . , where two SULs from primary and secondary cells may be transmitted simultaneous. In a third valid case, the transmission status of case 1 can be expressed as 1T+0T+0T+1T+ . . . , where one NUL from a primary cell and one SUL from a secondary cell may be transmitted simultaneous. Similarly, in a fourth valid case, the transmission status of case 1 can also be expressed as 0T+1T+1T+0T+ . . . , where one NUL from a secondary cell and one SUL from a primary cell may be transmitted simultaneous.

As further illustrated below in Table 1, a second case indicates that one of the bands can be selected to support the simultaneous uplink transmissions on a carrier within the selected band, in which each selected band may correspond to either SUL carriers or NUL carriers depending on its frequency range of operation. As further illustrated below, the transmission status of each band for case 2 may vary based on the transmission switching rules. In a first valid case, the transmission status of case 2 can be expressed as 2T+0T+0T+0T+ . . . , where two uplink transmissions on a NUL carrier within band A, for example, may be transmitted simultaneous from a primary cell. In another example, the transmission status of a second valid case 2 can be expressed as 0T+2T+0T+0T+ . . . , where two uplink transmissions on a SUL carrier within band B may be transmitted simultaneous from a primary cell.

TABLE 1
Simultaneous Transmission of SUL, NUL from Different Cells

| | TX Status | |
|---|---|---|
| | of Each Band | TX Switching Rules |
| Case 1 | aT + bT + | Two bands among band pairs (a, b), (c, d), |
| | cT + dT + . . . | . . . are set to value “1” and rest are set to “0” |
| Case 2 | aT + bT + | One of bands (a, b, c, d, . . . ) are set to value |
| | cT + dT + . . . | “2” and rest are set to “0”, and the carrier or |
| | | band is same or different from Case 1. |

In one or more implementations, the UE 104 may be configured with a second transmission switching table (Table 2) that sets rules for the UE 104 to have a capability that supports the simultaneous transmission of only SUL carriers from different cells or the simultaneous transmission of only NUL carriers from different cells; however, the simultaneous transmission of a SUL carrier from one cell and a NUL carrier from another cell may be restricted (or not allowed). In some implementations, the UE 104 may refrain from transmitting simultaneously on the first carrier and on the second carrier when the first carrier and the second carrier are respectively configured as a supplementary uplink carrier and a non-supplementary uplink carrier from different cells.

As illustrated below in Table 2, a first case indicates that two bands among the band pairs can be selected to support the simultaneous uplink transmissions, in which only NUL carriers within the selected bands can be simultaneously transmitted from different cells, or alternatively, only SUL carriers within the selected bands can be simultaneously transmitted from different cells. In this regard, the transmission status of each band for a first valid case 1 can be expressed as 1T+0T+1T+0T+ . . . , where only two NUL carriers in bands A and C may be transmitted simultaneous from primary and secondary cells. Similarly, in a second valid case 1, the transmission status of each band can also be expressed as 0T+1T+0T+1T+ . . . , where only two SULs may be transmitted simultaneous from primary and secondary cells.

As further illustrated below in Table 2, a second case indicates that one of the bands can be selected to support the simultaneous uplink transmissions on a carrier within the selected band, in which a selected band may correspond to either the SUL carrier or the NUL carrier depending on its frequency range of operation. As further illustrated below, the transmission status of each band for case 2 may vary based on the transmission switching rules. For example, the transmission status of a first valid case 2 can be expressed as 2T+0T+0T+0T+ . . . , where two uplink transmissions on a NUL carrier within band A may be transmitted simultaneous from a primary cell. In another example, the transmission status of a second valid case 2 can be expressed as 0T+2T+0T+0T+ . . . , where two uplink transmissions on a SUL carrier within band B may be transmitted simultaneous from a primary cell. Other example uplink transmissions may be performed simultaneously within other band selections.

TABLE 2
No Simultaneous Transmission of SUL, NUL from Different Cells

| | TX Status | |
|---|---|---|
| | of Each Band | TX Switching Rules |
| Case 1 | aT + bT + | Two NULs of band pairs (a, b), (c, d), . . . are |
| | cT + dT + . . . | set to value “1” and rest are set to “0”, or |
| | | Two SULs of band pairs (a, b), (c, d), . . . are |
| | | set to value “1” and rest are set to “0” |
| Case 2 | aT + bT + | One of bands (a, b, c, d, . . . ) are set to value |
| | cT + dT + . . . | “2” and rest are set to “0”, and the carrier or |
| | | band is same or different from Case 1. |

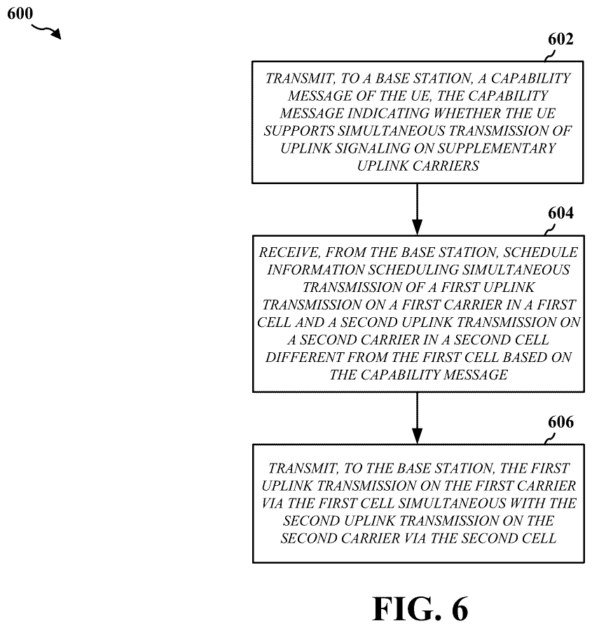

The UE 104 can transmit a UE capability message 504, in accordance with the first aspect described above with respect to FIG. 6. For example, the UE 104 may send the UE capability message via RRC signaling to the base station 102. In some aspects, the UE 104 may send the UE capability message as part of an initial registration process with the network.

At block 506, the base station 102 can schedule uplink transmissions of the UE 104 based on the UE capability message. For example, the base station 102 may schedule one or more uplink transmissions of the UE 104 (including simultaneous uplink transmissions on uplink carriers) with a corresponding location of fields in a downlink control channel (e.g., PDCCH) and an indication for time-frequency resources of the uplink transmissions (e.g. indication of time and frequency domain resources), including a set of frequency domain resources on the serving cell, a number of consecutive symbols, and a time domain granularity of each bit in the field. In some aspects, the first carrier as a supplementary uplink carrier is configured with PUCCH when the second carrier is a non-supplementary uplink carrier and the second cell is a primary cell. In other aspects, the first carrier as a supplementary uplink carrier is not configured with a PUCCH when the second carrier is a non-supplementary uplink carrier and the second cell is a secondary cell. The base station may then transmit to the UE 104 the schedule information via PDCCH 508. The UE 104 can receive the PDCCH 508 that includes the schedule information. For example, the schedule information may indicate scheduling of simultaneous transmission of a first uplink transmission 512 on a first carrier in a first cell (e.g., 102-1) and a second uplink transmission 514 on a second carrier in a second cell (e.g., 102-2) different from the first cell based on the capability message 504, in accordance with the second aspect described above with respect to FIG. 6. In some aspects, the base station 102 may include a single cell. In other aspects, the base station 102 may include (and/or support) multiple cells, such as a primary cell and a secondary cell. As illustrated in FIG. 5, the base station 102, for example, includes a first cell 102-1 and a second cell 102-2.

At block 510, the base station 102 may monitor the SUL/NUL carriers for an uplink transmission from the UE 104. In some aspects, the monitoring of the SUL/NUL carriers may be based on the schedule information provided by the base station 102.

The UE 104 can simultaneously transmit two uplink transmissions on respective carriers via different cells. For example, the UE 104 may transmit, to the base station 102, the first uplink transmission 512 on the first carrier via the first cell 102-1 simultaneous with the second uplink transmission 514 on the second carrier via the second cell 102-2, in accordance with the third aspect described above with respect to FIG. 6. In some aspects, each of the first carrier and the second carrier is one of a supplementary uplink carrier or a non-supplementary uplink carrier. In some implementations, the first carrier is a supplementary uplink carrier and the second carrier is a non-supplementary uplink carrier. In other implementations, the first carrier and the second carrier are each supplementary uplink carriers. In still other implementations, the first carrier and the second carrier are each non-supplementary uplink carriers.

FIG. 6 is a flowchart of a process 600 of wireless communication. The process 600 may be performed by a UE (e.g., the UE 104, 350) which may include the memory 360 and which may be the entire UE or a component of the UE, such as the TX processor 368, the RX processor 356, and/or the controller/processor 359. As illustrated, the process 600 includes a number of enumerated steps, but implementations of the process 600 may include additional steps before, after, and in between the enumerated steps. In some implementations, one or more of the enumerated steps may be omitted or performed in a different order.

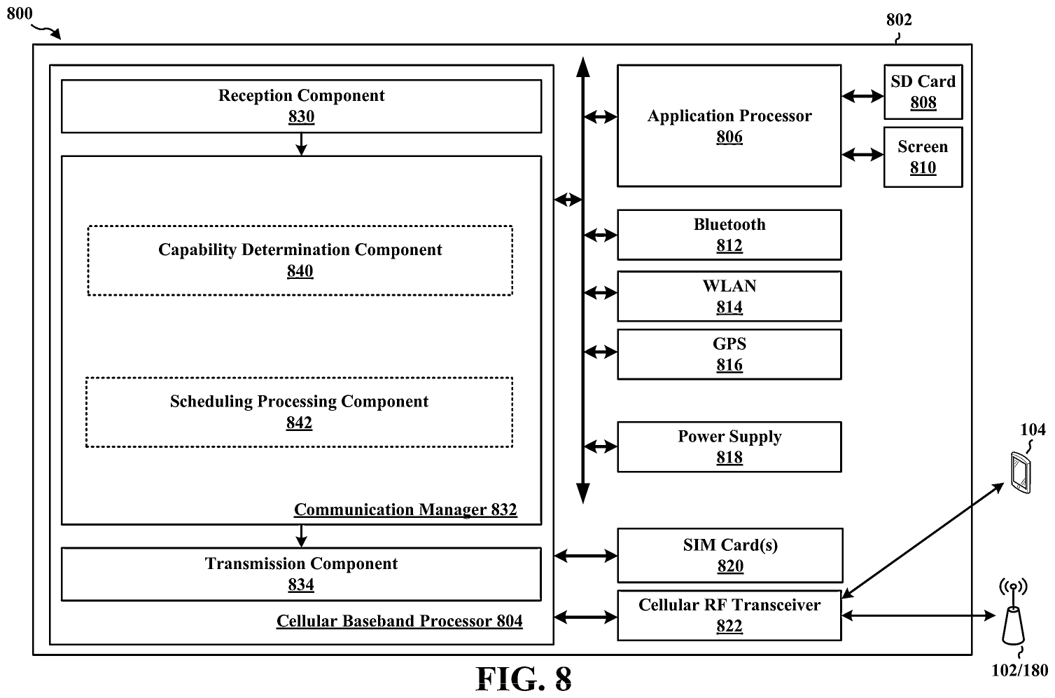

At 602, the UE transmits, to a base station (e.g., 102/180), the capability message of the UE, in which the capability message indicates whether the UE supports simultaneous transmission of uplink signaling on supplementary uplink carriers. The UE can transmit the capability message, e.g., as described in connection with FIGS. 1-5. For instance, 602 may be performed by one or more components described with respect to FIG. 3, e.g., controller/processor 359, transmit processor 368, receiver/transmitter 354 and/or antenna 352. The capability message may be transmitted, e.g., by the capability determination component 840 via the transmission component 834 of the apparatus 802 in FIG. 8. In the context of FIG. 5, the UE 104 station 102 may transmit, to the base station 102, the capability message 504.

At 604, the UE receives, from the base station, schedule information scheduling simultaneous transmission of a first uplink transmission on a first carrier in a first cell and a second uplink transmission on a second carrier in a second cell different from the first cell based on the capability message. The UE can receive the schedule information from the network, e.g., as described in connection with FIGS. 1-5. For instance, 604 may be performed by one or more components described with respect to FIG. 3, e.g., controller/processor 359, receive processor 356, receiver/transmitter 354 and/or antenna 352. The schedule information may be received, e.g., by the scheduling processing component 842 via the reception component 830 of the apparatus 802 in FIG. 8. In the context of FIG. 5, the UE 104 station 102 may receive the schedule information from the base station 102 via PDCCH 508.

At 606, the UE transmits, to the base station (e.g., 102/180), the first uplink transmission on the first carrier from the first cell simultaneous with the second uplink transmission on the second carrier from the second cell (different from the first cell). The UE can simultaneously transmit the first uplink transmission and the second uplink transmission on respective uplink carriers, e.g., as described in connection with FIGS. 1-5. For instance, 602 may be performed by one or more components described with respect to FIG. 3, e.g., controller/processor 359, transmit processor 368, receiver/transmitter 354 and/or antenna 352. The first and second uplink transmissions may be performed, e.g., by the scheduling processing component 842 via the transmission component 834 of the apparatus 802 in FIG. 8. In the context of FIG. 5, the UE 104 station 102 may simultaneously transmit the first uplink transmission 512 on a first carrier (e.g., SUL or NUL) via the first cell 102-1 and the second uplink transmission 514 on a second carrier (e.g., SUL or NUL) via the second cell 102-2.

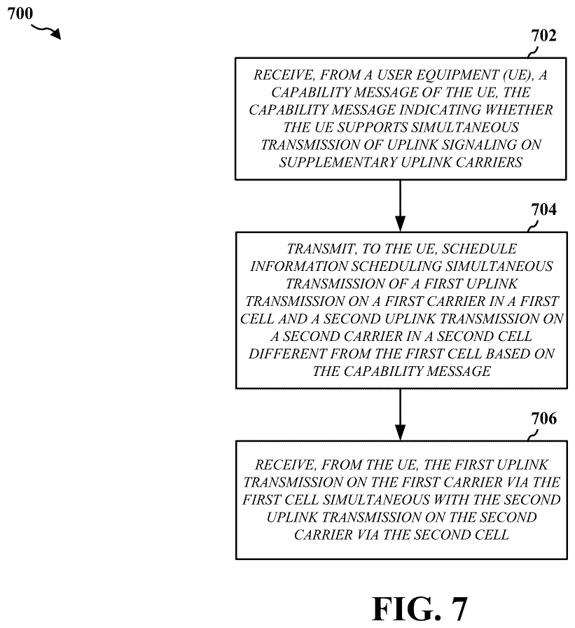

FIG. 7 is a flowchart of a process 700 of wireless communication. The process 700 may be performed by a base station (e.g., the base station 102/180, 310), which may include the memory 376 and which may be the entire base station or a component of the base station, such as the TX processor 316, the RX processor 370, and/or the controller/processor 375. As illustrated, the process 700 includes a number of enumerated steps, but implementations of the process 700 may include additional steps before, after, and in between the enumerated steps. In some implementations, one or more of the enumerated steps may be omitted or performed in a different order.

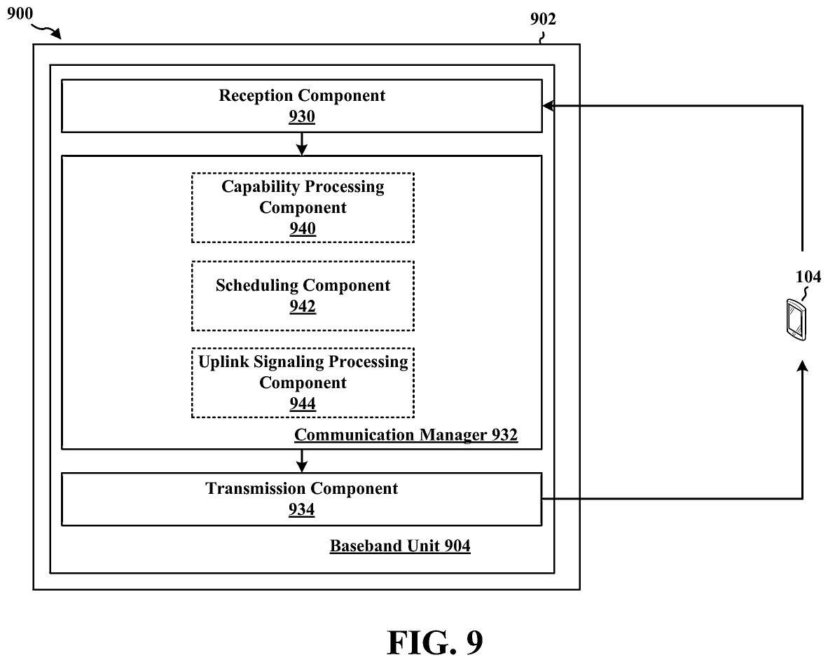

At 702, the base station may receive a capability message of the UE, in which the capability message indicates whether the UE supports simultaneous transmission of uplink signaling on supplementary uplink carriers. The base station can receive the capability message, e.g., as described in connection with FIGS. 1-5. For instance, 702 may be performed by one or more components described with respect to FIG. 3, e.g., controller/processor 375, receive processor 370, receiver/transmitter 318 and/or antenna 320. The capability message may be received, e.g., by the capability processing component 940 via the reception component 930 of the apparatus 902 in FIG. 9. In the context of FIG. 5, the base station 102 may receive, from the UE 104, the capability message 504.

At 704, the base station may transmit, to the UE, schedule information scheduling simultaneous transmission of a first uplink transmission on a first carrier in a first cell and a second uplink transmission on a second carrier in a second cell different from the first cell based on the capability message, e.g., as described in connection with FIGS. 1-5. For instance, 704 may be performed by one or more components described with respect to FIG. 3, e.g., controller/processor 375, transmit processor 316, receiver/transmitter 318 and/or antenna 320. The schedule information may be transmitted, e.g., by the scheduling component 942 via the transmission component 934 of the apparatus 902 in FIG. 9. In the context of FIG. 5, the base station 102 may

At 706, the base station may receive, from the UE, the first uplink transmission on the first carrier via the first cell simultaneous with the second uplink transmission on the second carrier via the second cell, e.g., as described in connection with FIGS. 1-5. For instance, 706 may be performed by one or more components described with respect to FIG. 3, e.g., controller/processor 375, receive processor 370, receiver/transmitter 318 and/or antenna 320. The first uplink transmission and the second uplink transmission may be simultaneously received, e.g., by the uplink signaling processing component 944 via the reception component 930 of the apparatus 902 in FIG. 9. In the context of FIG. 5, the base station 102 may receive, from the UE 104, the first uplink transmission on a first carrier (e.g., SUL or NUL) via the first cell 102-1 simultaneously with the second uplink transmission on a second carrier (e.g., SUL or NUL) via the second cell 102-2.

FIG. 8 is a diagram 800 illustrating an example of a hardware implementation for an apparatus 802. The apparatus 802 is a UE and includes a cellular baseband processor 804 (also referred to as a modem) coupled to a cellular RF transceiver 822 and one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, and a power supply 818. The cellular baseband processor 804 communicates through the cellular RF transceiver 822 with the UE 104 and/or BS 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 350 and may include the memory 360 and/or at least one of the TX processor 368, the RX processor 356, and the controller/processor 359. In one configuration, the apparatus 802 may be a modem chip and include just the baseband processor 804, and in another configuration, the apparatus 802 may be the entire UE (e.g., see 350 of FIG. 3) and include the aforementioned additional modules of the apparatus 802.

The transmission component 834 is configured to transmit, to a base station (e.g., 102/180), the capability message of the UE, in which the capability message indicates whether the UE supports simultaneous transmission of uplink signaling on supplementary uplink carriers, e.g., as described in connection with block 602 of the process 600 of FIG. 6.

The communication manager 832 includes a capability determination component 840 that is configured to determine whether the UE is configured to support simultaneous transmission of uplink signaling on supplementary uplink carriers. The communication manager 832 further includes a scheduling processing component 842 that receives schedule information scheduling simultaneous transmission of a first uplink transmission on a first carrier in a first cell and a second uplink transmission on a second carrier in a second cell different from the first cell based on the capability message, e.g., as described in connection with block 604 of the process 600 of FIG. 6.

Referring back to the transmission component 834, the UE can transmit, to the base station, the first uplink transmission on the first carrier from the first cell simultaneous with the second uplink transmission on the second carrier from the second cell (different from the first cell).

The apparatus may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 802, and in particular the cellular baseband processor 804, includes means for transmitting, to a base station, a capability message of the UE, in which the capability message indicates whether the UE supports simultaneous transmission of uplink signaling on supplementary uplink carriers. The apparatus 802 also includes means for receiving, from the base station, schedule information scheduling simultaneous transmission of a first uplink transmission on a first carrier in a first cell and a second uplink transmission on a second carrier in a second cell different from the first cell based on the capability message. The apparatus 802 also includes means for transmitting, to the base station, the first uplink transmission on the first carrier via the first cell simultaneous with the second uplink transmission on the second carrier via the second cell. The aforementioned means may be one or more of the aforementioned components of the apparatus 802 configured to perform the functions recited by the aforementioned means. As described supra, the apparatus 802 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 9 is a diagram 900 illustrating an example of a hardware implementation for an apparatus 902. The apparatus 902 is a BS and includes a baseband unit 904. The baseband unit 904 may communicate through a cellular RF transceiver with the UE 94. The baseband unit 904 may include a computer-readable medium/memory. The baseband unit 904 is responsible for general processing, including the execution of software stored on the computer-readable medium/memory. The software, when executed by the baseband unit 904, causes the baseband unit 904 to perform the various functions described supra. The computer-readable medium/memory may also be used for storing data that is manipulated by the baseband unit 904 when executing software. The baseband unit 904 further includes a reception component 930, a communication manager 932, and a transmission component 934. The communication manager 932 includes the one or more illustrated components. The components within the communication manager 932 may be stored in the computer-readable medium/memory and/or configured as hardware within the baseband unit 904. The baseband unit 904 may be a component of the BS 310 and may include the memory 376 and/or at least one of the TX processor 316, the RX processor 370, and the controller/processor 375.

The communication manager 932 includes a capability processing component 940, a scheduling component 942 and an uplink signaling processing component 944. The capability processing component 940 may be configured to process the received capability message of the UE. The capability processing component 940 may determine that the UE has the capability to support simultaneous transmission of uplink signaling on supplementary uplink carriers. The scheduling component 942 may be configured to generate and send schedule information that schedules simultaneous transmission of a first uplink transmission on a first carrier in a first cell and a second uplink transmission on a second carrier in a second cell different from the first cell based on the capability message. The uplink signaling processing component 944, with cooperation with the reception component 930, may receive, from the UE, the first uplink transmission on the first carrier via the first cell simultaneous with the second uplink transmission on the second carrier via the second cell.

The apparatus may include additional components that perform each of the blocks of the algorithm in the aforementioned flowchart of FIG. 7. As such, each block in the aforementioned flowchart of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the baseband unit 904, includes means for receiving, from a user equipment, a capability message of the UE, in which the capability message indicates whether the UE supports simultaneous transmission of uplink signaling on supplementary uplink carriers. The apparatus 902 also includes means for transmitting, to the UE, schedule information scheduling simultaneous transmission of a first uplink transmission on a first carrier in a first cell and a second uplink transmission on a second carrier in a second cell different from the first cell based on the capability message. The apparatus 802 also includes means for receiving, from the UE, the first uplink transmission on the first carrier via the first cell simultaneous with the second uplink transmission on the second carrier via the second cell.

The aforementioned means may be one or more of the aforementioned components of the apparatus 902 configured to perform the functions recited by the aforementioned means. As described supra, the apparatus 902 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The following examples illustrate example embodiments. The following examples are illustrative only and aspects of these examples may be used in combination with any of the other embodiments or teaching described herein, without limitation.

Example 1 is a method of wireless communication performed by a user equipment (UE) that includes transmitting, to a base station, a capability message of the UE, the capability message indicating whether the UE supports simultaneous transmission of uplink signaling on supplementary uplink carriers; receiving, from the base station, schedule information scheduling simultaneous transmission of a first uplink transmission on a first carrier in a first cell and a second uplink transmission on a second carrier in a second cell different from the first cell based on the capability message; and transmitting, to the base station, the first uplink transmission on the first carrier via the first cell simultaneous with the second uplink transmission on the second carrier via the second cell.

In Example 2, the method of Example 1 further includes generating the capability message based on one or more switching rules for uplink transmission switching, wherein each of the one or more switching rules indicates on which of a plurality of band pairs the UE is allowed to perform simultaneous transmission of multiple uplink carriers from different cells, wherein each of the plurality of band pairs includes a first band associated with a supplementary uplink carrier and a second band associated with a non-supplementary uplink carrier.

In Example 3, the method of Example 2, wherein the one or more switching rules indicates that one or more band combinations in the plurality of band pairs are allowed to support simultaneous transmission of multiple supplementary uplink carriers that are associated with the one or more band combinations.

In Example 4, the method of Example 2, wherein the one or more switching rules indicates that one or more band combinations in the plurality of band pairs are allowed to support simultaneous transmission of multiple non-supplementary uplink carriers that are associated with the one or more band combinations.

In Example 5, the method of Example 2, wherein the one or more switching rules indicates that one or more band combinations in the plurality of band pairs are allowed to support simultaneous transmission of a supplementary uplink carrier and a non-supplementary uplink carrier that are associated with the one or more band combinations.

In Example 6, the method of any of Examples 1-5 further includes that each of the first carrier and the second carrier is one of a supplementary uplink carrier or a non-supplementary uplink carrier.

In Example 7, the method of any of Examples 1-6 further includes that the first carrier is a supplementary uplink carrier and the second carrier is a non-supplementary uplink carrier.

In Example 8, the method of any of Examples 1-6 further includes that the first carrier and the second carrier are each supplementary uplink carriers.

In Example 9, the method of any of Examples 1-6 further includes that the first carrier and the second carrier are each non-supplementary uplink carriers.

In Example 10, the method of any of Examples 1-6 further includes refraining from transmitting simultaneously on the first carrier and on the second carrier when the first carrier and the second carrier are respectively configured as a supplementary uplink carrier and a non-supplementary uplink carrier from different cells.

In Example 11, the method of any of Examples 1-10 further includes that the first cell and the second cell are associated with a same cell group.

In Example 12, the method of any of Examples 1-11 further includes that the first cell is a primary cell (PCell) and the second cell is a secondary cell (SCell).

In Example 13, the method of any of Examples 1-12 further includes comprising receiving, from the base station, a physical downlink control channel (PDCCH), the PDCCH comprising the schedule information.

In Example 14, the method of any of Examples 1-13 further includes that the first carrier as a supplementary uplink carrier is configured with a physical uplink control channel (PUCCH) when the second carrier is a non-supplementary uplink carrier and the second cell is a primary cell.

In Example 15, the method of any of Examples 1-13 further includes that the first carrier as a supplementary uplink carrier is not configured with a physical uplink control channel (PUCCH) when the second carrier is a non-supplementary uplink carrier and the second cell is a secondary cell.

Example 16 is a device including one or more processors and one or more memories in electronic communication with the one or more processors storing instructions executable by the one or more processors to cause the system or apparatus to implement a method as in any of Examples 1 to 15.

Example 17 is a system or apparatus including means for implementing a method or realizing an apparatus as in any of Examples 1 to 15.

Example 18 is a non-transitory computer readable medium storing instructions executable by one or more processors to cause the one or more processors to implement a method as in any of Examples 1 to 15.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication performed by a user equipment (UE) comprising:
transmitting, to a base station, a capability message of the UE, the capability message indicating whether the UE supports simultaneous transmission of uplink signaling on supplementary uplink carriers;
receiving, from the base station, schedule information scheduling simultaneous transmission of a first uplink transmission on a first carrier in a first cell and a second uplink transmission on a second carrier in a second cell different from the first cell based on the capability message; and
transmitting, to the base station, the first uplink transmission on the first carrier via the first cell simultaneous with the second uplink transmission on the second carrier via the second cell.

2. The method of claim 1, further comprising generating the capability message based on one or more switching rules for uplink transmission switching, wherein each of the one or more switching rules indicates on which of a plurality of band pairs the UE is allowed to perform simultaneous transmission of multiple uplink carriers from different cells, wherein each of the plurality of band pairs includes a first band associated with a supplementary uplink carrier and a second band associated with a non-supplementary uplink carrier.

3. The method of claim 2, wherein the one or more switching rules indicates that one or more band combinations in the plurality of band pairs are allowed to support simultaneous transmission of multiple supplementary uplink carriers that are associated with the one or more band combinations.

4. The method of claim 2, wherein the one or more switching rules indicates that one or more band combinations in the plurality of band pairs are allowed to support simultaneous transmission of multiple non-supplementary uplink carriers that are associated with the one or more band combinations.

5. The method of claim 2, wherein the one or more switching rules indicates that one or more band combinations in the plurality of band pairs are allowed to support simultaneous transmission of the supplementary uplink carrier and the non-supplementary uplink carrier that are associated with the one or more band combinations.

6. The method of claim 1, wherein each of the first carrier and the second carrier is one of a supplementary uplink carrier or a non-supplementary uplink carrier.

7. The method of claim 1, wherein the first carrier is a supplementary uplink carrier and the second carrier is a non-supplementary uplink carrier.

8. The method of claim 1, wherein the first carrier and the second carrier are each supplementary uplink carriers.

9. The method of claim 1, wherein the first carrier and the second carrier are each non-supplementary uplink carriers.

10. The method of claim 1, wherein the first cell and the second cell are associated with a same cell group.

11. The method of claim 1, wherein the first cell is a primary cell (PCell) and the second cell is a secondary cell (SCell).

12. The method of claim 1, further comprising receiving, from the base station, a physical downlink control channel (PDCCH), the PDCCH comprising the schedule information.

13. The method of claim 1, wherein the first carrier as a supplementary uplink carrier is configured with a physical uplink control channel (PUCCH) when the second carrier is a non-supplementary uplink carrier and the second cell is a primary cell.

14. The method of claim 1, wherein the first carrier as a supplementary uplink carrier is not configured with a physical uplink control channel (PUCCH) when the second carrier is a non-supplementary uplink carrier and the second cell is a secondary cell.

15. An apparatus for wireless communication, comprising:
a memory; and
at least one processor coupled to the memory and configured to:
transmit, to a base station, a capability message of a user equipment (UE), the capability message indicating whether the UE supports simultaneous transmission of uplink signaling on supplementary uplink carriers;
receive, from the base station, schedule information scheduling simultaneous transmission of a first uplink transmission on a first carrier in a first cell and a second uplink transmission on a second carrier in a second cell different from the first cell based on the capability message; and
transmit, to the base station, the first uplink transmission on the first carrier via the first cell simultaneous with the second uplink transmission on the second carrier via the second cell.

16. The apparatus of claim 15, wherein the at least one processor is further configured to generate the capability message based on one or more switching rules for uplink transmission switching, wherein each of the one or more switching rules indicates on which of a plurality of band pairs the UE is allowed to perform simultaneous transmission of multiple uplink carriers from different cells, wherein each of the plurality of band pairs includes a first band associated with a supplementary uplink carrier and a second band associated with a non-supplementary uplink carrier.

17. The apparatus of claim 16, wherein the one or more switching rules indicates that one or more band combinations in the plurality of band pairs are allowed to support simultaneous transmission of multiple supplementary uplink carriers that are associated with the one or more band combinations.

18. The apparatus of claim 16, wherein the one or more switching rules indicates that one or more band combinations in the plurality of band pairs are allowed to support simultaneous transmission of multiple non-supplementary uplink carriers that are associated with the one or more band combinations.

19. The apparatus of claim 16, wherein the one or more switching rules indicates that one or more band combinations in the plurality of band pairs are allowed to support simultaneous transmission of the supplementary uplink carrier and the non-supplementary uplink carrier that are associated with the one or more band combinations.

20. The apparatus of claim 15, wherein each of the first carrier and the second carrier is one of a supplementary uplink carrier or a non-supplementary uplink carrier.

21. The apparatus of claim 15, wherein the first carrier is a supplementary uplink carrier and the second carrier is a non-supplementary uplink carrier.

22. The apparatus of claim 15, wherein the first carrier and the second carrier are each supplementary uplink carriers.

23. The apparatus of claim 15, wherein the first carrier and the second carrier are each non-supplementary uplink carriers.

24. The apparatus of claim 15, wherein the first cell and the second cell are associated with a same cell group.

25. The apparatus of claim 15, wherein the first cell is a primary cell (PCell) and the second cell is a secondary cell (SCell).

26. The apparatus of claim 15, wherein the at least one processor is further configured to receive, from the base station, a physical downlink control channel (PDCCH), the PDCCH comprising the schedule information.

27. The apparatus of claim 15, wherein the first carrier as a supplementary uplink carrier is configured with a physical uplink control channel (PUCCH) when the second carrier is a non-supplementary uplink carrier and the second cell is a primary cell.

28. The apparatus of claim 15, wherein the first carrier as a supplementary uplink carrier is not configured with a physical uplink control channel (PUCCH) when the second carrier is a non-supplementary uplink carrier and the second cell is a secondary cell.

29. A computer-readable medium storing computer executable code, the code when executed by a processor cause the processor to:
transmit, to a base station, a capability message of a user equipment (UE), the capability message indicating whether the UE supports simultaneous transmission of uplink signaling on supplementary uplink carriers;
receive, from the base station, schedule information scheduling simultaneous transmission of a first uplink transmission on a first carrier in a first cell and a second uplink transmission on a second carrier in a second cell different from the first cell based on the capability message; and
transmit, to the base station, the first uplink transmission on the first carrier via the first cell simultaneous with the second uplink transmission on the second carrier via the second cell.

30. An apparatus for wireless communication, comprising:
means for transmitting, to a base station, a capability message of a user equipment (UE), the capability message indicating whether the UE supports simultaneous transmission of uplink signaling on supplementary uplink carriers;
means for receiving, from the base station, schedule information scheduling simultaneous transmission of a first uplink transmission on a first carrier in a first cell and a second uplink transmission on a second carrier in a second cell different from the first cell based on the capability message; and
means for transmitting, to the base station, the first uplink transmission on the first carrier via the first cell simultaneous with the second uplink transmission on the second carrier via the second cell.
